(19) United States
(12) Patent Application Publication
(10) Pub. No.: US 2023/0169602 A1
(43) Pub. Date: Jun. 1, 2023

(54) System Facilitating Government Mitigation of Damage at Public and Private Facilities

(71) Applicant: Alan Martin, McAlester, OK (US)

(72) Inventor: Alan Martin, McAlester, OK (US)

(21) Appl. No.: 18/102,572

(22) Filed: Jan. 27, 2023

Related U.S. Application Data
(63) Continuation-in-part of application No. 17/245,676, filed on Apr. 30, 2021.

(51) Int. Cl. G06Q 40/08; G06Q 30/04; G06T 7/00; G06V 20/10; G06V 20/62; G06V 30/413; G06V 40/16

(52) U.S. Cl. CPC G06Q 40/08; G06Q 30/04; G06T 7/0004; G06V 20/176; G06V 20/625; G06V 30/413; G06V 40/172; G06T 2207/30184; G06V 2201/08

(57) ABSTRACT

A software and hardware system (a web server) interoperating with a variety of recording devices (smart phones, tablet computers, and portable (personal) computers) facilitating the mitigation of damage to immobile public and private facilities caused by transport vehicles is disclosed. More specifically, the disclosed software and hardware system relates to a method of efficiently repairing and billing insurance companies for damage to immobile public and private facilities caused by automobiles and trucks and automobile and truck drivers and owners.

### CROSS-REFERENCE TO RELATED APPLICATIONS

This application makes reference to, and includes by reference, U.S. patent application Ser. No. 17/245,676 filed Apr. 30, 2021.

### FIELD OF THE INVENTION

The invention relates generally to a software and hardware system for the mitigation of damage to public and private facilities caused by transport vehicles. More specifically, the invention relates generally to a software and hardware system for the mitigation of damage to immobile public and private facilities caused by automobiles and trucks and automobile and truck drivers and owners. More specifically, the disclosed invention relates to a system that facilitates the rapid and efficient billing of insurance companies for damage to public and private facilities caused by automobiles and trucks and automobile and truck drivers and owners. The immobile public and privately owned physical facilities to which damage is mitigated are roadways, bridges, guard rails, cable barriers, right-of-way, medians, culverts, fences, any type of barricade, concrete divider, or any other type of traffic control device that could be damaged by a motor vehicle. Also, the invention both discloses a software and hardware system and a method of using the software and hardware system to mitigate damage to immobile public and private facilities caused by automobiles and trucks and automobile and truck drivers and owners.

### BACKGROUND OF THE INVENTION

Drivers cause damage on the road. Accidents and other mishaps involving cars, trucks, airplanes, and boats cause physical damage to immobile public and quasi-public (private) infrastructure. In the United States, such damage must be repaired by the governmental entity charged with repairing such immobile public and quasi-public (private) damage. For example, in most of the United States the city or county or parish in which an accident occurs is responsible for repairing damage to immobile public and quasi-public (private) physical facilities including bridges, railings, roadbeds, medians, culverts, drainage systems, fences and retaining walls, traffic signals, utilities, and the like while the state is responsible for repairing damage to immobile public and quasi-public (private) physical facilities including bridges, railings, roadbeds, medians, culverts, drainage systems, fences and retaining walls, traffic signals, utilities, and the like outside the boarders of cities, counties, and parishes.

Tracking these multiple repair tasks and locations is essentially a manual job. The management of these jobs is supported by various computer-based applications such as digital cameras, spreadsheets, email systems, and collaboration software. Nowhere, however, is a single, centralized portal or gateway that manages the entire process involved in mitigating damage caused by a vehicle or a vehicle operator including: 1) Visually documenting the damage at the time of the accident; 2) Taking or acquiring visual records such as photographs of the parties involved in the accident; 3) Taking or acquiring the insurance and licensure records of the responsible entit(ies) at the time of the damage; 4) Locating and identifying the damaged immobile public or private facility at a later repair or assessment date; and, 5) Documenting and certifying the repair after it is completed. Steps 1) through 3) must be completed and communicated very quickly to localize the collected data in a single, central location. This must be done to maximize the “first record” effect, where rapidly recording the first record of data associated with an accident is crucial. Time is of the essence. Human interactivity and the physical delay associated with mailing, shipping, and posting will not suffice. Finally, statistical analysis of the location of significant areas where accidents repeatedly occur is not tracked or provided. Nor is the time required to collect and centrally store the information collected or statistically analyzed.

Therefore, what is needed is a software and hardware system that visually, textually, and audibly records, or acquires these records, regarding an accident site at, or about, the time of an accident or mishap. Moreover, time is of the essence. Human interactivity and the physical delay associated with mailing, shipping, and posting will not suffice.

Also, what is needed is a software and hardware system that visually records, or otherwise acquires, photographs of the operator(s) of the vehicle(s) thought to be at fault in causing the damage. In some jurisdictions photographs of the operator(s) of the vehicle(s) thought to be not at fault in causing the damage are also recorded. The system must synchronize these photographic records electronically, in real time upon presentation.

Also, what is needed is a software and hardware system that visually records, or otherwise acquires, photographs of the insurance records, licensure records, permit records, etc. of the operator(s) of the vehicle(s) thought to be at fault in causing the damage. In some jurisdictions photographs of the insurance records, licensure records, permit records, etc. of the operator(s) thought to be not at fault in causing the damage are also recorded. The system must synchronize these photographic records electronically, in real time upon presentation.

Also, what is needed is a software and hardware system that allows the relocation of the accident site at a later date (for repair or for inspection) by means of photographs tied to a map.

Also, what is needed is a software and hardware system that allows the relocation of the accident site at a later date (for certification after repair) by means of photographs tied to a map.

Also, a method of reviewing the locations of accidents or mishaps that have occurred on a map is provided. By this means, engineers and law enforcement personnel may review collected (historical) accident data visually presented on a map.

Also what is needed is a method of using a software and hardware system to mitigate damage to immobile public and private facilities caused by automobiles and trucks and automobile and truck drivers and owners.

Finally, what is needed is a system and method that collects and communicates: 1) The identity of the responsible party; 2) The identity of the non-responsible party (if there is one); 3) Data identifying (locating) the site; 4) Data identifying the damage; and, 5) Data identifying the vehicle or vehicles that cause the damage data instantly or near instantly. Time is of the essence. Human interactivity and the physical delay associated with human handing, mailing, shipping, and posting will not suffice.

### SUMMARY OF THE INVENTION

According to a first embodiment of the present invention, a software and hardware system is disclosed which collects input from a recording device such as a smart phone, tablet computer, personal computer, etc. The recording device is used to: 1) Visually and audibly document the damage at the time of the accident; 2) Take visual records such as photographs of the parties involved in the accident; 3) Take the insurance and licensure records of the responsible entit(ies) at the time of the damage; 4) Locate and identifying the damaged immobile public or private facility at a later repair or assessment date; and, 5) Document and certifying the repair after it is completed. Also, statistical analysis of the location of significant areas where accidents repeatedly occur may be tracked and visualized. These functions are performed by a web server interacting with a multiplicity of recording devices. The recording devices must be wirelessly connected to the web server in real-time or near real-time or may be physically or manually connected (not in real-time).

As a first step, a law enforcement officer when investigating an automobile accident or incident takes one or more digital photos of the physical surroundings of a vehicular accident (caused by an automobile or truck) to record any physical damage caused to immobile publicly or privately owned facilities such as railings, bridge abutments and structures, traffic signals, pavement (aprons, roads, parking areas), parking payment systems (e.g. meters), etc. The photographic or video images are captured by a recording device. The geographic coordinates of each photo taken (including the time of day and direction the camera was pointing in when the photo was taken) are stored with the photos. The photos are transmitted wirelessly to the webserver in real-time or near real-time or may be physically or manually connected (not in real-time).

As a second step, the law enforcement officer takes one or more digital photos of the driver's license of the operator(s) of the at fault vehicle(s), the registration certificate(s) of the at fault vehicles, the vehicle identification numbers (VINs) of the at fault vehicles, and the at fault vehicles themselves. The photographic or video images are captured by a recording device. The geographic coordinates of each photo taken (including the time of day and direction the camera was pointing in when the photo was taken) are stored with the photo. In some jurisdictions (depending on traffic regulations and/or insurance regulations) the investigator may be required to take one or more digital photos of the driver's license of the operator(s) of the not at fault vehicle(s), the registration certificate(s) of the not at fault vehicles, the vehicle identification numbers (VINs) of the not at fault vehicles, and the not at fault vehicles themselves. The photographic or video images are captured by a recording device. The geographic coordinates of each photo taken (including the time of day and direction the camera was pointing in when the photo was taken) are stored with these photos. The photos are transmitted wirelessly to the webserver in real-time or near real-time or may be physically or manually connected (not in real-time). Also, these records may be collected from a database of public records maintained by the state.

As a third step, the law enforcement officer takes one or more digital photos of the insurance certificates associated with the operator(s) of the at fault vehicle(s). In some jurisdictions (depending on traffic regulations and/or insurance regulations) the investigator may be required to takes one or more digital photos of the insurance certificates associated with the operator(s) of the not at fault vehicle(s). The photographic or video images are captured by a recording device. The geographic coordinates of each photo taken (including the time of day and direction the camera was pointing in when the photo was taken) are stored with each of these photos. The photos are transmitted wirelessly to the webserver in real-time or near real-time or may be physically or manually connected (not in real-time). Also, these records may be collected from a database of public records maintained by the state.

This photographic record of the site of the accident or mishap, the vehicle(s) both at fault and (under some circumstances) not at fault, and the insurance certificates covering the at fault and (under some circumstances) the not at fault driver(s) and vehicle(s) are transferred to a web server. Here the photographic record is stored and archived. It must be emphasized that in one embodiment of the present invention rapidity in capturing, transferring, and storing the photographic and other data is a necessity. This must be done to maximize the “first record” effect, where rapidly recording the first record of data associated with an accident is crucial.

At a subsequent date, the record is retrieved and loaded onto a recording device operated by a repair worker. The repair worker uses the stored geographic coordinates associated with the multiplicity of stored photograph to generally locate the physical site of the accident or mishap. Then, the repair worker uses the stored images of the accident site to locate and visualize the damage that was caused. After repairing the damage, the repair worker takes one or more digital photos of the repaired physical damage to record the repairs made to publicly and privately owned facilities such as immobile public and quasi-public (private) physical facilities including bridges, railings, roadbeds, medians, culverts, drainage systems, fences and retaining walls, traffic signals, utilities, and the like. These photographic or video images are captured by the recording device. The geographic coordinates of each photo taken (including the time of day and direction the camera was pointing in when the photo was taken) are stored with each photo. The photos are transmitted electronically or manually to the web server. The recording devices may be cellularly connected to the web server in real-time or near real-time or virtually (physically connected) or manually (not in real-time) using email, text-message, and other data sharing systems (like Dropbox).

At a second subsequent date, a governmental account auditor generates an invoice including the labor cost of the repair workers and the cost(s) associated with the repair material(s) used to repair the governmental or privately owned facility. Next, depending on the regulations of the governmental entity, the auditor makes a claim against the insurance policy designated by the insurance policy derived from the insurance certificate(s) of the at fault (and under some circumstances the not at fault operators) associated with records in the database. The governmental account auditor may include photographs showing the accident site, the at fault (and possibly not at fault) vehicles, the at fault (and possibly not at fault) operators of those vehicles, the insurance certificates (or insurance data) of the at fault (and possibly not at fault) operators of those vehicles, and the photographs of the accident site after repairs were made as part of the claim.

### DESCRIPTION OF DRAWINGS

FIG. 1 is diagram showing the general operation of the information collection phase of the first embodiment of a system facilitating government mitigation of damage at immobile public and private facilities.

FIG. 2 is flowchart showing the first embodiment of a system facilitating government mitigation of damage at immobile public and private facilities showing how information is collected and stored.

FIG. 3 is a flowchart showing the first embodiment of a system facilitating government mitigation of damage at immobile public and private facilities showing how information is used by repair agents.

FIG. 4 is a flowchart showing the first embodiment of a system facilitating government mitigation of damage at immobile public and private facilities showing how information is used by government account auditors to bill insurance carriers.

### DETAILED DESCRIPTION OF THE EMBODIMENTS

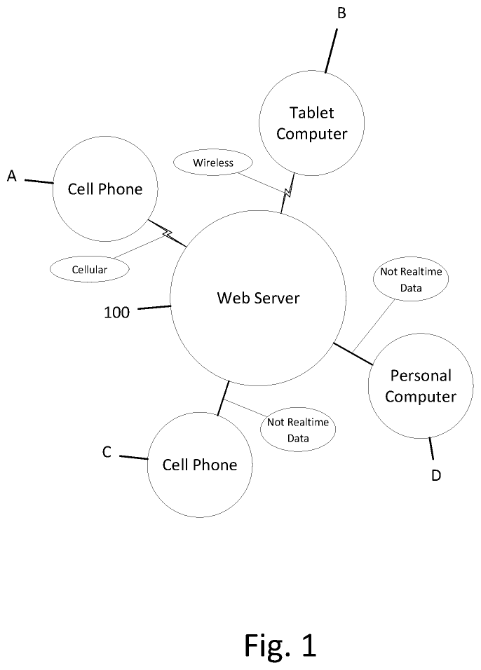

Turning now to FIG. 1, according to a first embodiment of the present invention, a software and hardware system (a web server 100) is disclosed which collects input from a recording device such as a smart phone A and C, tablet computer B, personal computer D, etc. Smart phone A and C, tablet computer B, and personal computer D are wirelessly connected to the central server. The recording device is used to: 1) Visually and audibly document the damage at the time of the accident; 2) Take visual records such as photographs of the parties involved in the accident; 3) Photograph or otherwise capture the insurance and licensure records of the responsible entit(ies) at, or shortly after, the time of the damage; 4) Locate and identifying the damaged immobile public or private facility at a later repair or assessment date; and, 5) Document and certifying the repair after it is completed. Also, statistical analysis of the location of significant areas where accidents repeatedly occur may be tracked and visualized.

These functions are performed by the web server 100 interacting with a multiplicity of recording devices A, B, C, and, D. The recording devices A, B, C, and, D may be cellularly connected to the web server 100 in real-time or near real-time (as shown with cell phone A and tablet computer B) or virtually (physically connected) or manually (not in real-time as shown by cell phone C and personal computer D) using email, text-message, and other data sharing systems (like Dropbox).

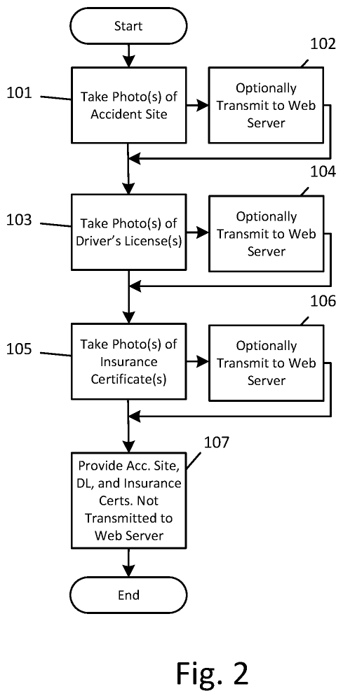

Turn now to FIGS. 1 and 2, as a first step, a law enforcement officer when investigating an automobile accident or incident takes one or more digital photos of the physical surroundings of a vehicular accident (caused by an automobile or truck) to record any physical damage caused to immobile public and quasi-public (private) facilities such as railings, bridge abutments and structures, traffic signals, pavement (aprons, roads, parking areas), parking payment systems (e.g. meters), etc. The photographic or video images are captured by a recording device A, B, C, and/or, D (101). The geographic coordinates of each photo taken (including the time of day and direction the camera was pointing in when the photo was taken) are stored with the photos. The photos are optionally transmitted cellularly to the web server 100 (102).

As a second step, the law enforcement officer takes one or more digital photos of the driver's license of the operator(s) of the at fault vehicle(s), the registration certificate(s) of the at fault vehicle(s), the vehicle identification number(s) (VINs) of the at fault vehicle(s), and the at fault vehicle(s) themselves. The photographic or video images are captured by a recording device A, B, C, and/or, D (103). The geographic coordinates of each photo taken (including the time of day and direction the camera was pointing in when the photo was taken) are stored with the photo. In some jurisdictions (depending on traffic regulations and/or insurance regulations) the investigator may be required to take one or more digital photos of the driver's license of the operator(s) of the not at fault vehicle(s), the registration certificate(s) of the not at fault vehicles, the vehicle identification number(s) (VINs) of the not at fault vehicle(s), and the not at fault vehicle(s) themselves. The photographic or video images are captured by a recording device A, B, C, and/or, D (103). The geographic coordinates of each photo taken (including the time of day and direction the camera was pointing in when the photo was taken) are stored with these photos. The photos are optionally transmitted cellularly to the web server 100 (104). Also, these records may be collected from a database of public records maintained by the state or a private entity.

As a third step, the law enforcement officer takes one or more digital photos of the insurance certificates associated with the operator(s) of the at fault vehicle(s). In some jurisdictions (depending on traffic regulations and/or insurance regulations) the investigator may be required to takes one or more digital photos of the insurance certificates associated with the operator(s) of the not at fault vehicle(s). The photographic or video images are captured by a recording device A, B, C, and/or, D (105). The geographic coordinates of each photo taken (including the time of day and direction the camera was pointing in when the photo was taken) are stored with each of these photos. The photos are optionally transmitted cellularly to the web server 100 (106). Also, these records may be collected from a database of public records maintained by the state or a private entity.

As discussed above, this photographic record of the site of the accident or mishap, the vehicle(s) both at fault and (under some circumstances) not at fault, and the insurance certificates covering the at fault and (under some circumstances) the not at fault driver(s) and vehicle(s) may be optionally transmitted cellularly to web server 100. Here the photographic record is stored and archived. If the photographic records were not optionally transmitted cellularly to the web server, they are virtually (physically connected) or manually (not in real-time as shown by cell phone C and personal computer D) transferred using email, text-message, and other data sharing systems (like Dropbox) (107).

Some of the necessary data may be provided outside of one of the above discussed photographic means. For example, the insurance certificate may not be available as a photograph or digital record. It is possible to input the data into the web server 100 derived from the insurance certificate manually if the insurance policy number is included on, for example, the investigating officer's incident report or derived from a database of public records maintained by the state or a private entity. As discussed above, all photographic and textually recorded records associated with the accident may be supplied (in real-time or non-real-time) to the web server 100 by cellular, wi-fi, Bluetooth, or direct, physical connection.

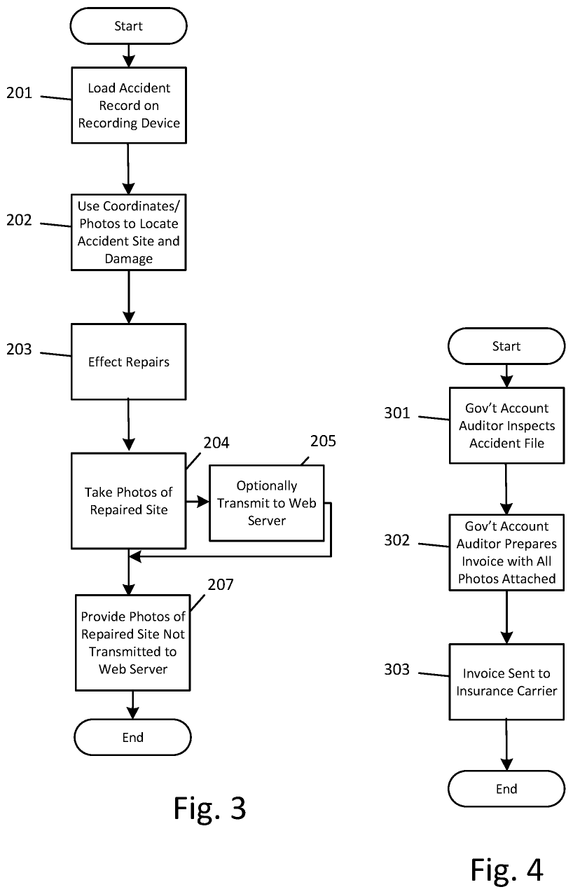

Referring now to FIGS. 1 and 3, at a subsequent date, the record is retrieved and loaded onto a recording device operated by a repair worker (201). The repair worker uses the stored geographic coordinates associated with the multiplicity of stored photographs to generally locate the physical site of the accident or mishap (202). Then, the repair worker uses the stored images of the accident site to locate and visualize the damage that was caused (202). After repairing the damage (203), the repair worker takes one or more digital photos of the repaired physical damage to record the repairs made to publicly and privately owned facilities such as immobile public and quasi-public (private) bridges, railings, roadbeds, medians, culverts, drainage systems, fences and retaining walls, traffic signals, utilities, and the like (204). These photographic or video images are captured by the recording device A, B, C, and/or, D. The geographic coordinates of each photo taken (including the time of day and direction the camera was pointing in when the photo was taken) are stored with each photo. The photos are transmitted electronically or manually to the web server (205). The recording devices may be wirelessly connected to the web server in real-time or near real-time or may be physically connected and recorded data manually.

Referring now to FIGS. 1 and 4, at a second subsequent date, a governmental account auditor retrieves and analyzes the document file associated with a specific accident or incident (301). Next, the auditor generates an invoice including the labor cost of the repair workers and the cost(s) associated with the repair material(s) used to repair the governmental or quasi-governmental (privately owned) facility (302). The governmental account auditor may include photographs showing the accident site, the at fault (and possibly not at fault) vehicles, the at fault (and possibly not at fault) operators of those vehicles, the insurance certificates (or insurance data) of the at fault (and possibly not at fault) operators of those vehicles, and the photographs of the accident site after repairs were made as part of the claim. Other photographic or textual data may be included. Next, depending on the regulations of the governmental entity, the auditor makes a claim against the insurance policy designated by the insurance certificate(s) of the at fault (and under some circumstances the not at fault operators) associated with records in the database (303).

Another embodiment of the present invention is disclosed. This embodiment recapitulates the steps described above, however, the time to collect the photographic evidence of the accident and the supporting evidence (i.e., the identity of the at fault vehicle; the identity of the at fault driver; and the identity of the insurance policy and carrier associated with the at fault driver must be collected and stored instantly or nearly instantly. This must be done to maximize the “first record” effect, where rapidly recording the first record of data associated with an accident is critical to statistically assess the market as it changes. Such changes may occur very rapidly, and time is of the essence. Human interactivity and the physical delay associated with mailing, shipping, and posting will not suffice.

Another method of using the system is disclosed. This method discloses the steps necessary to use the system to mitigate damage to immobile public and private facilities caused by automobiles and trucks and automobile and truck drivers and owners as disclosed above. This is in adherence to the “first record” effect, where rapidly recording the first record of data associated with an accident is critical to statistically assess the market as it changes. Such changes may occur very rapidly, and time is of the essence.

Further, what is needed is a system and method that rapidly and securely collects and communicates: 1) The identity of the responsible party; 2) The identity of the non-responsible party (if there is one); 3) Data identifying (locating) the site; 4) Data identifying the damage; and, 5) Data identifying the vehicle or vehicles that cause the damage data very quickly. Time is of the essence. Human interactivity and the physical delay associated with human handing, mailing, shipping, and posting will not suffice. After collecting the information disclosed above, the system re-rates the insurance policy of the at fault driver, ordinarily leading to a positive adjustment in the rate charged for issuing the insurance policy.

Finally, the terms “collecting,” “storing,” “retrieving,” “using,” and “forwarding” are not meant to suggest any particular mode of collection, storage, retrieval, usage, or forwarding. However, such modes of collection, storage, retrieval, usage, and forwarding must be rapid, secure, and feature centralized storage of all collected data. Time is of the essence. Human interactivity and the physical delay associated with human handling, mailing, shipping, and posting will not suffice. Such modes of collection, storage, retrieval, usage, and forwarding must therefore be completely automatic, computer, network, and database based.

What is claimed is:

1. A method of mitigating damage caused by an automobile or truck accident comprising the following steps:
a) instantly or nearly instantly collecting and storing:
i) photographic evidence documenting damage at an immobile public or quasi-public (private) facility taken shortly after the accident or incident that caused the damage and taken before any mitigation indexed with the GPS coordinate of the damage;
ii) photographic evidence of the identity of the operator of the vehicle causing the damage;
iii) photographic evidence of the identity of the vehicle causing the damage;
iv) photographic evidence of identifying an insurance company and an insurance policy associated with the automobile or truck and the operator causing the damage;
b) retrieving and using the evidence collected and stored in steps a) i) through a) iv) at a subsequent date to locate the site of the accident or incident and repair the damage associated with the accident or incident;
c) instantly or nearly instantly make a record of the repair by storing photographic evidence of the repair associated with the GPS coordinates of the repair completed in step b);
d) instantly or nearly instantly retrieving and using the evidence collected in steps a) i) through a) iv) and step b) and step c) to prepare an invoice including the labor cost of the repair workers and the cost(s) associated with the repair material(s) used to repair the governmental or quasi-governmental (privately owned) facility;
e) forwarding the invoice to the at-fault operator's insurance company for payment.

2. A method of claim 1 where the evidence of the identity of the operator is a photograph of the driver's license of the operator.

3. A method of claim 1 where the evidence of the identity of the operator is a photograph of the driver's license of the operator.

4. A method of claim 1 where the evidence of the identity of the operator is a photograph of a transcription of the driver's license of the operator.

5. A method of claim 1 where the evidence of the identity of the vehicle is a photograph of the vehicle showing the license plate.

6. A method of claim 1 where the evidence of the identity of the vehicle is a photograph of the vehicle showing vehicle identification number (VIN) plate.

7. A method of claim 1 where the evidence of the insurance policy associated with the operator and the vehicle is a photograph of the insurance registration receipt of the operator.

8. A method of claim 1 where the evidence of the insurance policy associated with the operator and the vehicle is a transcription of the insurance registration receipt of the operator.

9. A method of claim 1 where the evidence of the identity of the operator identifies the at fault operator.

10. A method of claim 1 where the evidence of the identity of the operator identifies the at fault operator and the not at fault operator.

11. A method of claim 1 where the evidence of the identity the vehicle causing the damage identifies the at fault vehicle.

12. A method of claim 1 where the evidence of the identity of the vehicle causing the damage identifies the at fault vehicle and the not at fault vehicle.

13. A method of claim 1 where the evidence identifying the insurance policy associated with the vehicle and the operator identifies the insurance policy associated with the at fault vehicle and the at fault operator.

14. A method of claim 1 where the evidence identifying the insurance policy associated with the vehicle and the operator identifies the insurance policy associated with the at fault vehicle and the at fault operator and the insurance policy associated with the not at fault vehicle and the not at fault operator.

15. A method of claim 1 where the rate paid for the insurance policy associated with the at fault vehicle is adjusted when steps a) i) through a) iv) are performed.

16. A method of claim 1 where the rate paid for the insurance policy associated with the not at fault vehicle is adjusted when steps a) i) through a) iv) are performed.
